(19) United States
(12) Patent Application Publication
(10) Pub. No.: US 2007/0143260 A1
(43) Pub. Date: Jun. 21, 2007

(54) Delivery of personalized keyword-based information using client-side re-ranking

(75) Inventors: Martin M. Markov, Bellevue, WA (US); Sachin Dhawan, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/311,795

(22) Filed: Dec. 19, 2005

(51) Int. Cl. G06F 7/00

(52) U.S. Cl. 707/3

(57) ABSTRACT

Search and information systems are provided that facilitate ranking of promotional material such as advertisements in view of personal information related to users who search for information from public databases. In one aspect, a search and information system is provided. The system includes a search component to locate data for a user based upon one or more words indicated by the user. A promotional component associates related information to the data, based in part on the one or more words indicated by the user. A personalization component facilitates ranking of the related information based in part on private information of the user that is isolated from the search component.

### BACKGROUND

Searching technology such as with search engines and other components is one of the main drivers for modern exchange of information between remote users and databases connected over the Internet for example. Along with providing search capabilities, search engine providers generally enable companies to promote themselves via advertisements that are linked to terms that may show up in word searches. For example, advertisers can define a set of keywords and supply them to the search engine providers. When searches are initiated, the keywords are matched to respective search terms to enable advertisements relating to those key words and search terms to be displayed. The search providers then can extract revenue from the advertisers based on the amount of advertisement activity that resulted from users of the search engine services.

In general, search companies often promote capabilities that allow their search-generated ads to connect advertisers with new customers at the moment when the customer is looking for related products or services. To support this endeavor, some search engine providers boast reaching more than eighty percent of Internet users. The search providers allow keywords to be defined, to create ads, to choose keywords that match ads to a target audience and pay for the service when someone actually clicks on the ads.

Advertisements can also be targeted to appear only in specific geographic locations. For instance, country-level targeting or narrowing search focus to region and city-level targeting. This allows showing ads to people searching for results in regional areas that are pre-selected by advertisers, for example. Customized targeting allows showing ads to people searching for results in a defined area including within a defined radius and within defined borders. When regional and local areas are defined, advertisers can reach prospects that are appropriate for a business which can write ads that highlight special promotions or pricing based on geography. Thus, keywords can also be defined to target local or regional businesses. The keywords system may analyze a searcher's query (for example “New York restaurant”) to establish what location that person is searching for. The system may also take note of the person's Internet Protocol (IP) address to see where he or she is searching from.

Today, the keywords advertisement business is growing extremely rapidly and many software companies and marketing agencies have become more and more interested to pursue new opportunities in this field. Keyword-based advertisement typically works in two ways where people explicitly type keywords (typically when using search engines) and they receive advertisements related to these keywords or keywords are extracted automatically from the content of documents and related advertisements are then delivered.

Classic examples that demonstrate the first approach are the search engines (MSN Search, Google, Yahoo, and so forth). The manner in which advertisements are delivered is generally straightforward. When the user is searching for some keyword(s), the search query is used to deliver both search results (documents) and advertisements related to the keyword(s). The second approach is a slightly more complex—the keywords are automatically extracted from web pages (e.g., Google's AdSense technology), e-mails (e.g., Google's gMail) and other documents. After the extraction, these keywords are sent to a server that returns related advertisements.

Keyword-based advertisements have a huge advantage over other types of advertisements because they are much more personalized to the customer. If one were to search for a car, they will receive ads for cars. However, this personalization is very weak and incomplete since the information relating to the customer themselves is usually very limited, incomplete and could be inaccurate. A common problem which is not yet addressed by existing technology is to deliver target-specific advertisements and at the same time to respect the privacy of the users. This is a difficult problem since there are at least two major barriers. In one case, it is difficult to collect a lot of information regarding the users. Secondly, there are serious privacy implications with collecting and using certain types of personal information.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Personalization components are provided to enable reception of search-related advertising in a privatized and focused manner. Such components allow advertising that is pushed to users during keyword searches (or extracted keywords) to be privately processed on the client-side of received search activity in order to generate more personalized and targeted advertising or promotion to the user. By locating the personalization components on the client end in one aspect, promotional material such as advertising can be narrowed or ranked according to personal preferences of the users without exposing such preferences to search engine servers, other public databases, or other public processing utilities. Thus, advertising can be focused to the actual personal desires of search engine users that also mitigate the overall amount of extraneous ads that may be presented to users in conventional search and advertising systems. In addition, private information that is employed to narrow or focus respective advertising via the personalization components is kept out of the public domain by limiting its exposure from such domains.

In one case, exposure is limited by employing the personalization components on the client-side and re-ranking, arranging, filtering or ordering received promotions on the client in view of private information that is managed by the personalization component. Such personalization components can include policy components for defining user preferences, user profiles or models that indicate or determine user preference or personalization information, and/or intelligent components such as learning models that operate in the background to automatically determine personal preferences of users. In another aspect, personalization information can be encapsulated from public exposure and employed on the server side to narrow respective advertising that may be presented. For example, encapsulation of private information may include encryption techniques to mitigate revealing of confidential user information from the server while enabling searches to be focused at the server in view of the private user information.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a search and information system that provides personalized promotional information.

FIG. 2 is a flow diagram that illustrates a client-side ranking process for promotional information.

FIG. 3 is a flow diagram that illustrates a server-side ranking process for promotional information.

FIG. 4 illustrates a profile database for collecting personalization information.

FIG. 5 illustrates adjustment options for a search and personalization system.

FIG. 6 illustrates searching across local and/or remote system resources.

FIG. 7 illustrates example user model for ranking or filtering search results.

FIG. 8 illustrates an example search interface tool for interacting with search engines and promotional data.

FIG. 9 is a schematic block diagram illustrating a suitable operating environment.

FIG. 10 is a schematic block diagram of a sample-computing environment.

### DETAILED DESCRIPTION

Search and information systems are provided that facilitate ranking of promotional material such as advertisements in view of personal information related to users who search for information from public databases such as across the Internet. Personal information is kept private from public search engines or databases in one aspect by isolating such information at client components that are provided to rank or filter the promotional material based on the private information. In one aspect, a search and information system is provided. The system includes a search component to locate data for a user based upon one or more words indicated by the user. A promotional component associates related information with the data, based in part on the one or more words indicated by the user. A personalization component facilitates ranking of the related information based in part on private information of the user that is isolated from the search component. The search component employs keywords that are obtained explicitly from the user or obtained implicitly from retrieved documents, where the promotional component can generate advertising in one example that is related information to the data.

As used in this application, the terms “component,” “engine,” “profile,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

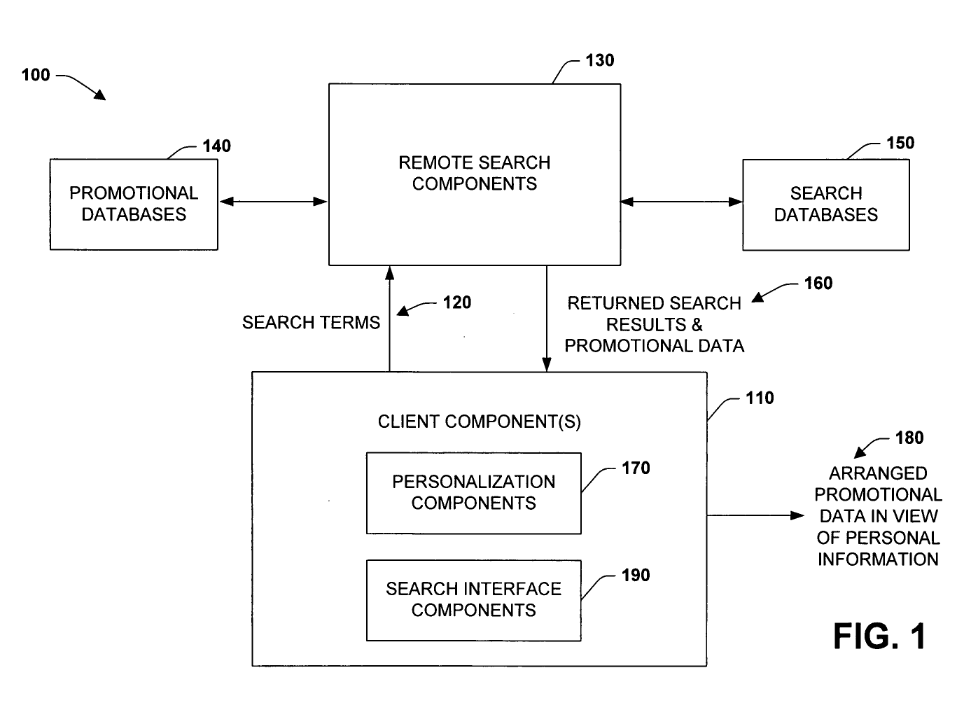

Referring initially to FIG. 1, a search and information system 100 is illustrated for distributing personalized promotional information to users. A client component 110 (or components) sends one or more search terms 120 to at least one search engine 130. The search engine 130 can be associated with one or more promotional databases 140 and one or more search databases 150 such as the plurality of data servers that supply the Internet for example. It is to be appreciated however that searching can occur in a local and/or remote environment such as initiating a search across a local database and moving to a remote database if the local search were not satisfied. In general, the promotional databases 140 include data that is auxiliary to the users primary search requirement contained in the search databases 150. This data includes advertising data, data that may be of interest to the user, supplemental data, and substantially any type of data that is associated with the users underlying search requirements or material related thereto.

After a search has been initiated with the search components 130, one or more returned search results and promotional data is returned at 160. The client component 110 employs one or more personalization components 170 to automatically arrange, filter, re-rank, or organize promotional data at 180. Typically, the personalization components 170 include private and personal information related to a user of various search interface components 190 such as a browser interface to a search portal, for example. The personalization components 170 can include user profile information or automatically derived user information from a learning component or background model for example that are described in more detail below.

In one specific example not related to advertising per se, the search databases 150 could be a local company database and the promotional database 140 may be information that the company desires to distribute to its employees. Thus, when a search is initiated at the client component 110 by the employee material from the promotional database 140 may be delivered at 160 in addition to the requested information from the search database 150. In one example, the employee may be asking about pension benefits. Depending on the detected age of the employee as indicated by the personalization components 170, additional retirement information may be supplied or ranked ahead of other benefit information supplied from the search itself.

One method provided is using client-side re-ranking of the advertisements (ads) based on the information collected implicitly (by indexing documents, files, and so forth) and/or explicitly (the user provides the information) on the user's personal computer (PC) and captured by the personalization components 170. Thus, the information which resides on the user's PC can be used together with information provided by the user (if any) to understand what that person is interested in and to deliver better ads or other promotional material to the respective person. One aspect is how to keep this personal information safe and generally not allow it to cross the boundaries of the user's PC. There are at least two methods to use this information and deliver personalized ads including:

Sending personalization data together with the keyword(s) and receive the personalized ads from the server. As will be described in more detail below, privacy components can be initiated on the server to keep the private information isolated from the public domain. In another aspect, only the keyword(s) are sent to the search components 130 or servers, thus all ads are received from the server and then personalize (re-rank) the ads on the user's PC at 110 so they can better fit the user's profile. Some of the ads could be filtered out optionally, highlighted, rearranged, and so forth. Generally, both approaches can be employed to deliver personalized ads. However, the first approach where some information is sent to the search server may not protect the personal information quite as well.

The second approach provides an isolation barrier where the personal information is protected and thus does not cross the boundaries of the user's PC at 110. This focuses on personalization of keyword-based ads on client side by performing personalization without submitting and sharing personal information with the search engine. This includes indexing documents on the client machine in order to create a customer profile model which is used in the process of personalization along with re-ranking (or other ordering) process) of keyword-based ads on client-side. One implementation would employ both client and server modules. The server module will receive keywords and return ads to the client along with relevant search information. The client side is a little bit more complex. It should be able perform the following operations:

1) Send one or more keywords and receive the ads.

2) Use the documents and other information on the user's PC to determine the profile of the user.

3) Use the profile to re-rank and/or filter the ads so the user gets more interesting and more personalized ads.

One possible choice to implement the solution in practice is to use the following components and infrastructure provided by search services:

1) A delivery engine—this component delivers ads for given keywords.

2) Toolbar—a toolbar which is very popular, with millions of downloads and users are very familiar with. It provides the interface and internal functionality to type keywords and send the requests.

3) Desktop Search—a search service which is capable of automatically indexing documents on the user's PC and also provides easy-to-use query interface which is also available through public APIs.

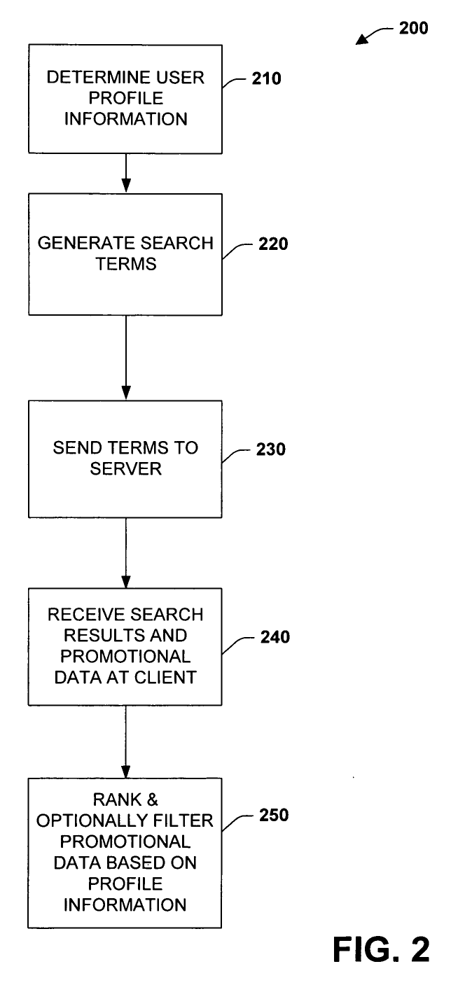

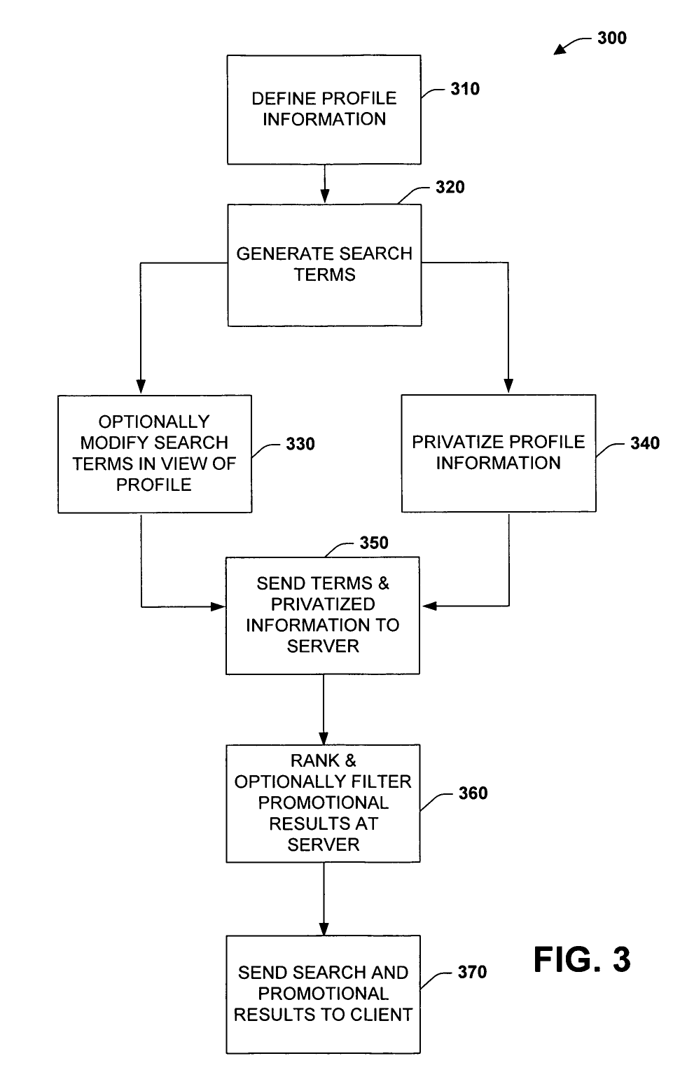

FIGS. 2 and 3 illustrate exemplary processes for processing and distributing promotional data such as advertisements in accordance with a search activity. While, for purposes of simplicity of explanation, the processes are shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Referring now to FIG. 2, an example process 200 is illustrated where personalization information is processed at the client side to keep such information isolated from the public domain. Proceeding to 210, user profile or personalization information is determined. This can include user surveys, background monitor data, learning data and substantially any type of data that indicates a user's personal information. At 220, one or more search terms are generated. This is typically at a browser where terms may be submitted to various search entities. Local searching on a local intranet can also be performed. At 230, the search terms are sent to a server where they are processed to return results from the user's query. Terms from the query can be employed to locate related promotional data or advertising.

At 240, search results and promotional data is received at the client side for further processing. Before presenting the promotional data to the user, personalization components are invoked to re-rank the data to be more in line with the users personal preferences. This can include weighting or scoring data as a perceived interest or relevance based upon a similarity to the user's profile or stated preferences. Along with re-ranking, other options can include rearranging displays, filtering ads from view, or highlighting ads or data that may be of increased importance to the user.

Referring to FIG. 3, an example process 300 is illustrated where personalization information is processed at the server and/or client side to keep such information isolated from the public domain. Similar to above at 310, user profile or personalization information is determined and at 320, one or more search terms are generated. This is typically at a browser where terms may be submitted to various search entities. Local searching on a local intranet can also be performed. At 300, the search terms can be processed in view of the personalization information or profile before they are sent to a server where they are processed to return results from the user's query. Terms from the query can be employed to locate related promotional data or advertising. Such processing could be to add, eliminate, or modify terms in the query in order to trigger personal ad generation at the server.

At 340, personal information could be privatized on the client side before being sent to the server. This could include encryption techniques to limit private information disclosure. This may also include use a agreements with the server such that the private information is only used to rank or filter adds and then discarded without further use. At 350, the modified queries or the privatized personal data is sent to the server for search result and promotional data processing. At 360, ads that are triggered from the keywords can be ranked or filtered as previously described. At 370, results and related ads that have been personalized for the user are sent to the client machine for the user.

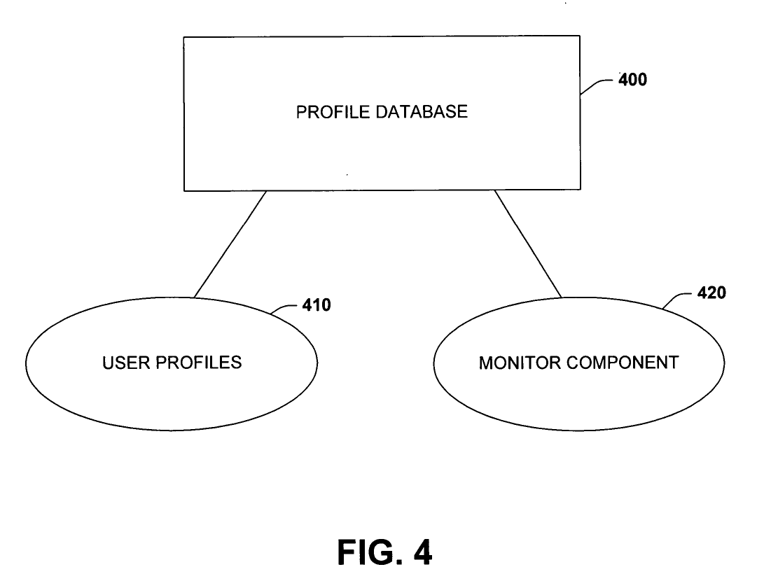

Turning to FIG. 4, a profile database 400 is illustrated for storing personalization information. In one aspect, the profile database 400 accepts personalization data from one or more user profiles 410, wherein respective profiles contain one or more items that identify personal items describing aspects of the user. Such items can include age or demographic information, personal interests such as hobbies, survey information concerning preferences for differing products, income level, educational information, purchasing options, and substantially any type of data that indicates a personal preference of the user. Data can be collected form users in substantially any form such as from interfaces and stored in various forms to enable ranking, sorting, or filtering ads from searches. At 420, a monitor component may operate in the background of a user's machine and collect data as the user interacts with the machine or applications running on the machine. This can include drawing inferences about the user and employing learning components to determine personal traits of the user to facilitate advertisement processing.

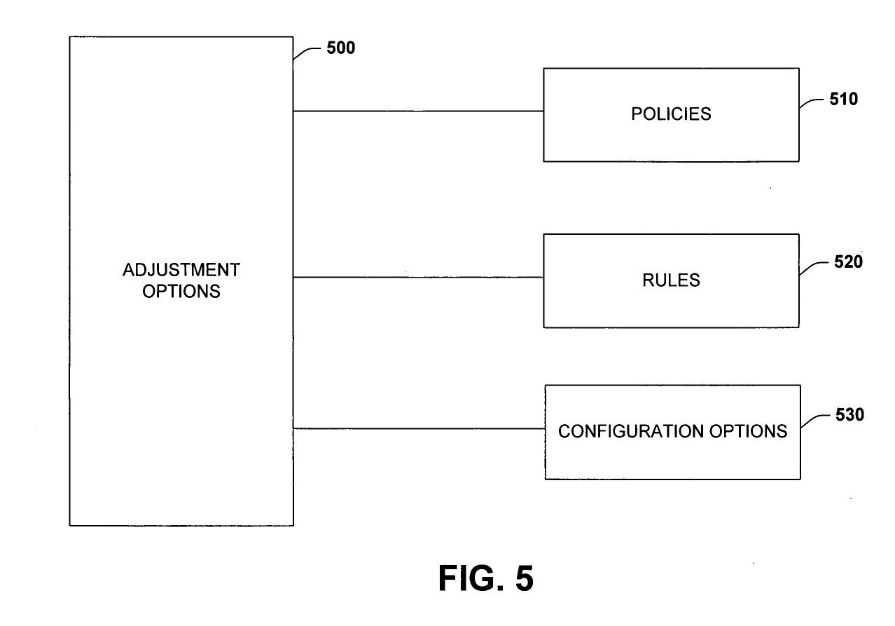

FIG. 5 illustrates adjustment options 500 for a search and personalization system. In this aspect, adjustment options 500 include components that allow users to control how and when personalization is applied to control delivery of promotional data. At 510, adjustments or controls can include one or more policies. For instance, some users may desire to control the actual amount of ads that are pushed by setting a policy on such amounts. Other policies may control where personalization is actually applied. For example, one policy may state that personalization is only to be applied at the client side where another policy may allow some personal information to be employed at the server in a limited or isolated manner. At 520, one or more rules may be programmed that control ad delivery or personalization. This may include logical constructs and interfaces for setting conditions such as if this condition and this condition then enable delivery scenario A. As can be appreciated, substantially any type of logical or Boolean operations may be provided to link conditions and outputs that control system searching and/or personalization. At 530, one or more configuration options may be provided to control ad personalization and/or presentation. This can include providing selection options on an interface menu for setting conditions on how the system is to operate.

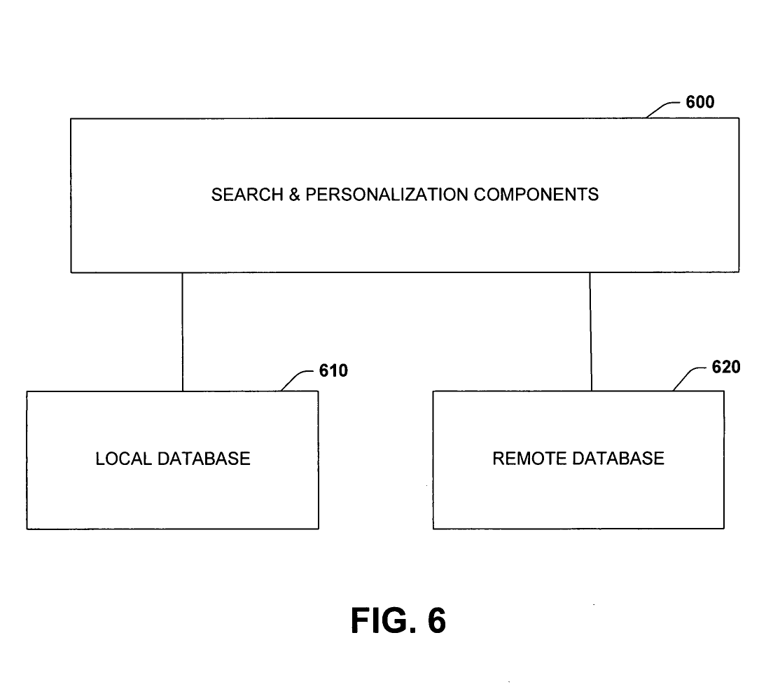

FIG. 6 illustrates searching across local and/or remote system resources. In this aspect, search and personalization components 600 can be designed to operate across local databases 610 and/or remote databases 620. For instance, a search can be commenced locally and then attempted remotely if the local database did not satisfy search requirements. Promotional data however could be aggregated from one or more of the local or remote sources however, regardless of whether or not the search was satisfied from either of the sources. Similarly, if a search were satisfied from one of the sources at 610 or 620, it would be possible to push promotional data from these sources without consulting the other database or databases. As described above, depending on how the user has configured a particular machine, it is possible to run personalization processing strictly at a client machine, on the server machine, and/or on a combination of client and/or server resources.

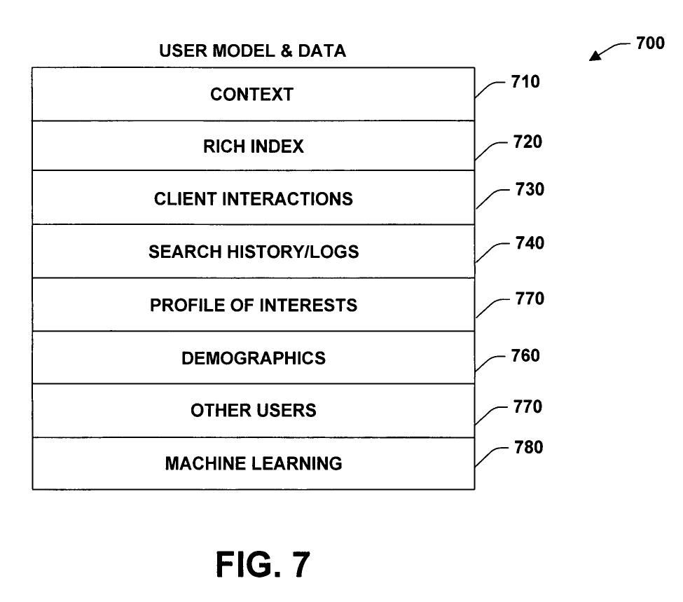

FIG. 7 illustrates an example user model 700 and data that may be employed to model and capture personalized user information. The user model 700 is employed to augment data searches and results/promotional ranking from generalized searches and to facilitate rich data processing according to determined user activity data. One aspect in successful personalization is to build a model of the user that accurately reflects their interests and is easy to maintain and adapt to changes regarding long-term and short-term interests. The user model can be obtained from a variety of sources, including but not limited to: From a history of computing context at 710 which can be obtained from local, mobile, or remote sources (e.g., applications open, content of those applications, and detailed history of such interactions including locations); From an index of content previously encountered at 720 (e.g., documents, web pages, email, Instant Messages, notes, calendar appointments, and so forth); From monitoring client interactions at 730 including recent or frequent contacts, topics of interest derived from keywords, relationships in an organizational chart, appointments, and so forth; From a history or log of previous web pages or local/remote data sites visited including a history of previous search queries at 740; From a profile of user interests at 750 which can be specified explicitly or implicitly derived via background monitoring; From demographic information at 760 (e.g., location, gender, age, background, job category, and so forth).

From the above examples, it can be appreciated that the user model 700 can be based on many different sources of information. For instance, the model 700 can be sourced from a history or log of locations visited by a user over time, as monitored by devices such as the Global Positioning System (GPS). When monitoring with a GPS, raw spatial information can be converted into textual city names, and zip codes. The raw spatial information can be converted into textual city names, and zip codes for positions a user has paused or dwelled or incurred a loss of GPS signal, for example. The locations that the user has paused or dwelled or incurred a loss of GPS signal can identified and converted via a database of businesses and points of interest into textual labels. Other factors include logging the time of day or day of week to determine locations and points of interest.

In other aspects, components can be provided to manipulate parameters for controlling how a user's personalized information, appointments, views of documents or files, activities, or locations can be grouped into subsets or weighted differentially in matching procedures for personalization based on type, age, or other combinations. For example, a retrieval algorithm could be limited to those aspects of the user's model that pertain to the query (e.g., documents that contain the query term or past interaction with data). Similarly, email may be analyzed from the previous month, whereas web accesses from the previous days, and the user's content created within the last year. It may be desirable that location information is used from only today or other time period. The parameters can be manipulated automatically to create subsets (e.g., via an optimization process that varies parameters and tests response from user or system) or users can vary one or more of these parameters via a user interface, wherein such settings can be a function of the nature of the query, the time of day, day of week, or other contextual or activity-based observations.

Models can be derived for individuals or groups of individuals at 770 such as via collaborative filtering techniques that develop profiles by the analysis of similarities among individuals or groups of individuals. Similarity computations can be based on the content and/or usage of items. It is noted that modeling infrastructure and associated processing can reside on client, multiple clients, one or more servers, or combinations of servers and clients.

At 780, machine learning techniques can be applied to learn user characteristics and interests over time as well as how and when data is interacted with by users. The learning models can include substantially any type of system such as statistical/mathematical models and processes for modeling users and determining preferences and interests including the use of Bayesian learning, which can generate Bayesian dependency models, such as Bayesian networks, naive Bayesian classifiers, and/or other statistical classification methodology, including Support Vector Machines (SVMs), for example. Other types of models or systems can include neural networks and Hidden Markov Models, for example. Although elaborate reasoning models can be employed, it is to be appreciated that other approaches can also utilized. For example, rather than a more thorough probabilistic approach, deterministic assumptions can also be employed (e.g., no recent searching for X amount of time of a particular web site may imply by rule that user is no longer interested in the respective information). Thus, in addition to reasoning under uncertainty, logical decisions can also be made regarding the status, location, context, interests, focus, and so forth of the users.

The learning models can be trained from a user event data store (not shown) that collects or aggregates data from a plurality of different data sources. Such sources can include various data acquisition components that record or log user event data (e.g., cell phone, acoustical activity recorded by microphone, Global Positioning System (GPS), electronic calendar, vision monitoring equipment, desktop activity, web site interaction and so forth). It is noted that the systems can be implemented in substantially any manner that supports personalized query and results processing. For example, the system could be implemented as a server, a server farm, within client application(s), or more generalized to include a web service(s) or other automated application(s) that interact with search functions such as user interfaces and search engines.

Before proceeding, collaborative filter techniques applied at 770 of the user model 700 are described in more detail. These techniques can include employment of collaborative filters to analyze data and determine profiles for the user. Collaborative filtering systems generally use a centralized database about user preferences to predict additional topics users may desire or additional components to determine how to rank and/or filter respective promotional data. Collaborative filtering can be applied with the user model 700 to process previous user activities from a group of users that may indicate preferences for a given user that predict likely or possible profiles for new users of a system. Several algorithms including techniques based on correlation coefficients, vector-based similarity calculations, and statistical Bayesian methods can be employed.

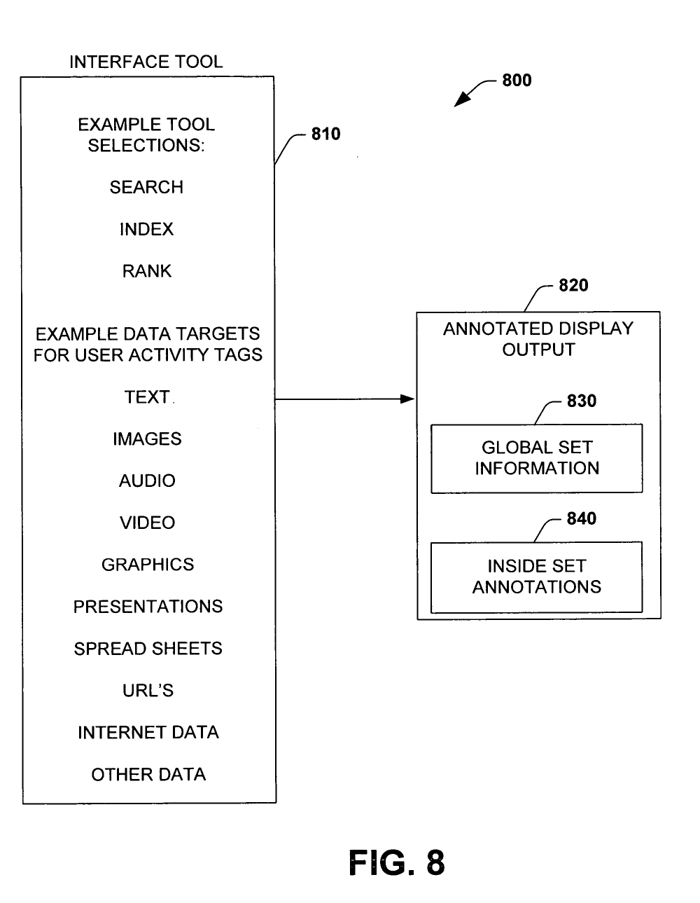

Referring to FIG. 8, a search interface system 800 is illustrated. In this example, an interface tool 810 (e.g., user interface applied to a local and/or remote database), can be associated with an output or display 820. The tool 810 can include many features for processing data from one or more databases. For example, the tool 810 may include selections for enabling data searches, indexing or cataloging of data, ranking of data, and so forth. Such data can include textual data such as XML data or ASCII data for example. Other data includes image data, audio data, video data, graphics data, and/or presentation data such as contained in a series of slides, for example. Substantially any data type or application can be employed including spread sheets, Universal Resource Location (URL) information, Internet or Web data, and so forth. The data can be organized, re-ranked, filtered, or arranged at the display 820 according to the user's personalized data described above. Alternatively, such data can be tagged such as in a column or as file metadata to indicate a score or a weight that is indicative of relative score or merit of interest to the user. The interface tool 810 can search, retrieve, or process the data to refine or determine more manageable subsets of data for users. As searches are iterated, personalization data can be employed to supply more targeted data such as advertising that is automatically tailored to the user's preference in view of the profiles and models described above.

The output from the tool 810 can be a file or an actual user interface display. For instance, if the tool were employed as a search engine within a database, the output could be a display of returned results and related promotional or advertising data that was ranked according to user profile information. The returned information can be global in nature as illustrated at 830. This may include highlighting or applying graphics to a file or result set to indicate that one file or grouping of files or results have been selected because of their increased importance to the user. In an Internet search tool for example, the tool 810 may be applied to search for all data that have the keyword computer and have had at least one graphical image associated with the data in the past month. Searches can be crafted in a plurality of ways and can include combinations of content searching, activity-based searching, and or combinations thereof. For instance, in this example, three returned ads out of a set of ten adds may be highlighted (or ranked above other ads) in one color as having a higher importance or score than the other returned adds which are delineated in a different color or not presented to the user at all.

In another aspect at 840, information within a returned file or promotional data set can be highlighted or annotated to indicate components of the set that may be more relevant to the user (e.g., four paragraphs within a given advertisement from a grouping of ads are highlighted or marked to indicate higher relevance to the user based on personalized information).

In addition to various hardware and/or software components, various interfaces can be provided to manipulate searches and promotional data. This can include a Graphical User Interface (GUI) 810 to interact with the model or other components of a search engine such as any type of application that sends, retrieves, processes, and/or manipulates data, receives, displays, formats, and/or communicates data, and/or facilitates operation of the application. For example, such interfaces can also be associated with an engine, server, client, editor tool or web browser although other type applications can be utilized.

The GUI 810 can include the display 820 having one or more display objects (not shown) for manipulating the model including such aspects as configurable icons, buttons, sliders, input boxes, selection options, menus, tabs and so forth having multiple configurable dimensions, shapes, colors, text, data and sounds to facilitate operations with the user model and search components. In addition, the GUI 810 can also include a plurality of other inputs or controls for adjusting and configuring one or more aspects. This can include receiving user commands from a mouse, keyboard, speech input, web site, remote web service and/or other device such as a camera or video input to affect or modify operations of the GUI 810.

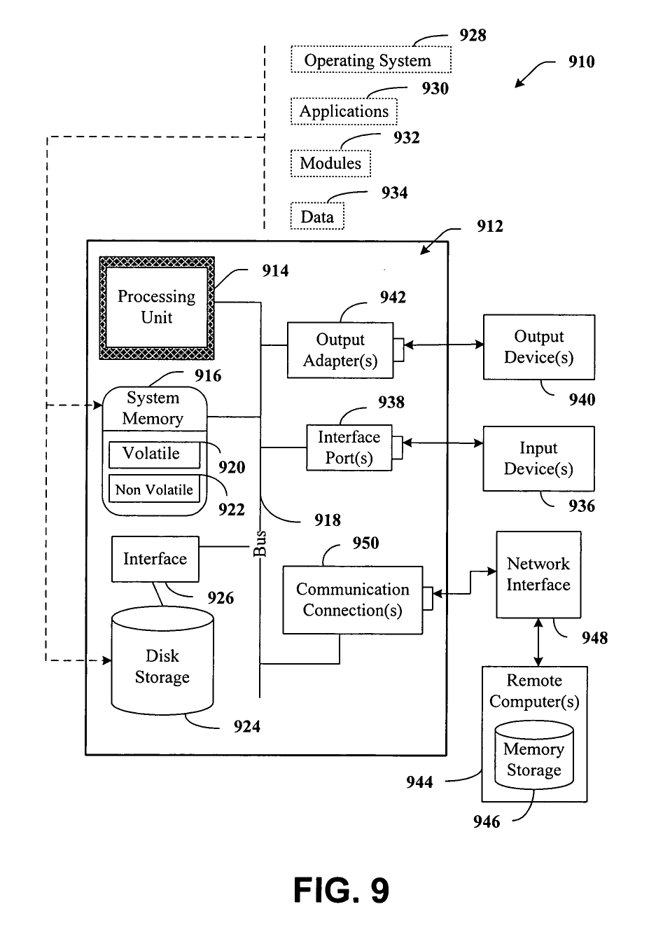

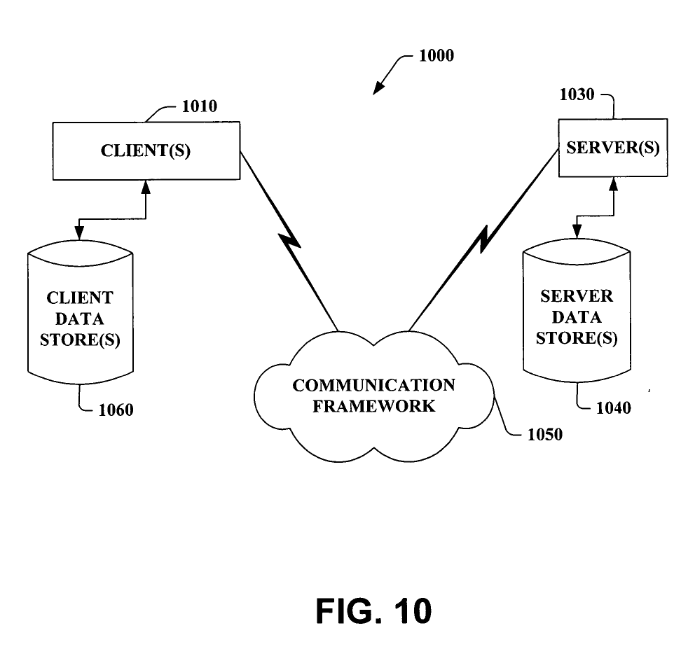

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch...), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI.

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A search and information system, comprising:
a search component to locate data for a user based upon one or more words indicated by the user;
a promotional component that associates related information to the data, based in part on the one or more words indicated by the user; and
a personalization component to facilitate a ranking of the related information based in part on private information of the user that is isolated from the search component.

2. The system of claim 1, the search component employs keywords that are obtained explicitly from the user or obtained implicitly from retrieved documents.

3. The system of claim 1, the promotional component generates advertising that is the related information to the data.

4. The system of claim 1, personalization component is associated with a client component that sends one or more search terms to at least one search engine, the search engine is associated with one or more promotional databases and one or more search databases.

5. The system of claim 4, the client component initiates a search across a local database and moves to a remote database if a local search is not satisfied.

6. The system of claim 4, the promotional database includes advertising data, data of interest to the user, supplemental data, and data that is associated with the user's underlying search requirements.

7. The system of claim 1, the personalization component automatically arranges, filters, re-ranks, or organizes promotional received from the search component.

8. The system of claim 7, the personalization component processes private and personal information in accordance with a browser application.

9. The system of claim 7, the personalization component is associated with at least one learning component to determine the personal and private information.

10. The system of claim 9, further comprising a user profile component to determine the personal and private information.

11. The system of claim 1, further comprising a component that sends personalization data with the keyword in order to receive personalized ads from a server.

12. The system of claim 11, the server includes one or more privacy components to isolate private information from the public domain.

13. The system of claim 1, further comprising a toolbar that provides an interface and internal functionality to type keywords and to send requests.

14. The system of claim 1, further comprising a search service which automatically indexes documents on a user's computer and provides a query interface which is available through one or more application programming interfaces.

15. The system of claim 1, further comprising a computer readable medium having computer executable instructions stored thereon to execute the search component, the promotional component, or the personalization component.

16. A method to provide personalized information during a search, comprising:
sending one or more keywords to at least one search engine;
pushing promotional information to a user based in part on the keywords; and
automatically organizing the promotional information based on personalization information of the user.

17. The method of claim 16, further comprising generating a user profile based upon background monitoring of the user.

18. The method of claim 17, further comprising employing a learning component to perform the background monitoring.

19. The method of claim 16, further comprising generating a user model to determine the personalization information.

20. A graphical user interface for a search and promotional database, comprising:
a browser component to enter one or more keywords of a search;
a display component to render results from the search;
an application component to rank promotional data associated with the search; and
a personalization component to supply user information that facilitates the rank of the promotional data.
